(19) United States
(12) Patent Application Publication
(10) Pub. No.: US 2013/0144809 A1
(43) Pub. Date: Jun. 6, 2013

(54) IMMEDIATE LICENSE FOR MEDIA FILE

(71) Applicants: Dave Durocher, Franklin, TN (US); Jason Collins, Franklin, TN (US); Steve Toland, LaCanada, CA (US); Yamel Hall, Franklin, TN (US)

(72) Inventors: Dave Durocher, Franklin, TN (US); Jason Collins, Franklin, TN (US); Steve Toland, LaCanada, CA (US); Yamel Hall, Franklin, TN (US)

(73) Assignee: SPLOTHER, INC., Franklin, TN (US)

(21) Appl. No.: 13/312,919

(22) Filed: Dec. 6, 2011

(51) Int. Cl. G06Q 30/06; G06F 21/00

(52) U.S. Cl. 705/400; 726/26

(57) ABSTRACT

One example embodiment includes a method of licensing a media file. The method includes allowing a licensee to select a media file. The method also includes producing a licensing agreement. The method further includes granting the licensee access to the media file.

### CROSS-REFERENCE TO RELATED APPLICATIONS

This application is related to co-pending U.S. Non-Provisional Patent Application Ser. No. ______, filed on Dec. 6, 2011, and entitled, “USER INTERFACE FOR SEARCH AND IMMEDIATE LICENSE FOR MEDIA FILE” (Attorney Docket No. 10228.3), which application is incorporated herein by reference in its entirety.

### BACKGROUND OF THE INVENTION

Licensing of copyrighted or other protected media files is a time consuming and, often, complicated process. In particular, the licensee has to determine who owns the media file, who is authorized to produce the license, negotiate the terms, obtain the media file, clear its use and complete other steps. This discourages many potential licensees from even attempting to license media file, especially for uses that are smaller in scale or audience.

In addition, the cost is often prohibitive. In particular, companies that own the licensing rights may “bundle” the desired media file with other media file that is related in some manner. The licensee may have no desire to use the other media file, but may not be able to obtain a license without doing so. This adds costs that may be prohibitive especially for smaller users.

The cost and complication means that many potential licensees are almost forced to obtain legal help in order to safely navigate the process. I.e., the potential danger is so high, that potential licensees are practically forced to obtain legal help to help avoid potential pitfalls.

Further, it may be some time before the user can obtain the necessary rights and files to use the media file. For example, a licensee may have trouble contacting his/her attorney on a weekend, much less obtaining the desired license on short notice. This means that licensees must plan sufficient time and hope that the process is completed in a timely manner.

Accordingly, there is a need in the art for a simplified licensing process. In addition, there is a need in the art for the media file to become immediately available. Further, there is a need in the art for a licensee to be able to see the source of costs.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of licensing a media file. The method includes allowing a licensee to select a media file. The method also includes producing a licensing agreement. The method further includes granting the licensee access to the media file.

Another example embodiment includes a system for allowing a user to obtain an immediate license to a media file. The system includes media storage, where the media storage is configured to store at least two media files. The system also includes a graphical user interface. The graphical user interface is configured to allow a licensee to select at least one of the at least two media files and determine the price of a license. The graphical user interface is also configured to present the license to the licensee and provide the licensee access to the selected media file.

Another example embodiment includes a system for allowing a user to obtain an immediate license to a media file. The system includes media storage, where the media storage is configured to store at least two media files. The system also includes a graphical user interface. The graphical user interface is configured to allow a licensee to select at least one of the at least two media files and determine the price of a license. The graphical user interface is also configured to present the license to the licensee and provide the licensee access to the selected media file. The system also includes a network, where the network allows the licensee to connect to the licensing system.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for licensing a media file;

FIG. 2 is a flowchart illustrating a method of licensing a media file;

FIG. 3 is a flowchart illustrating a method of licensing a media file;

FIG. 4 is a flowchart illustrating a method of producing a sync licensing agreement;

FIG. 5 illustrates an example of a user interface for selecting sync licensing options;

FIG. 6 is a flowchart illustrating a method of producing a mechanical licensing agreement;

FIG. 7 illustrates an example of a user interface for selecting mechanical licensing options;

FIG. 8 is a flowchart illustrating an example of a method for pricing a license; and

FIG. 9 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

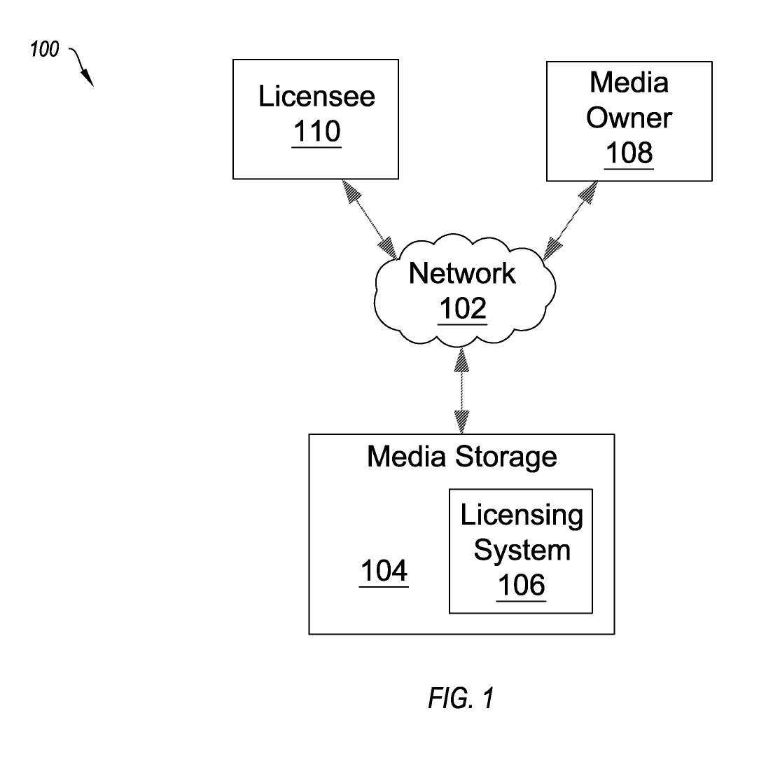

FIG. 1 illustrates an example of a system 100 for licensing a media file. In at least one implementation, the system 100 can allow access to the media file without the need to involve a human intermediary. I.e., the system 100 can allow the media file to be licensed and downloaded automatically, without any delay. In addition, the system 100 can allow the media file to be uploaded and made available without any delay in processing.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include media storage 104. In at least one implementation, the media storage 104 can include any system capable of storing and retrieving the desired media file. For example the media storage 104 can include an electronic database capable of electronically storing data. For example, the database 110 can include memory or memory banks. Additionally or alternatively, the media storage 104 can include processors or other logic devices capable of executing software or carrying out other computer algorithms. The media storage 104 can allow a user to access the hardware of the media storage 104 for remote computing or for information retrieval.

FIG. 1 further shows that the system 100 can include a licensing system 106. In at least one implementation, the licensing system is configured to determine the price of a license. I.e., the licensing system 106 can automatically determine the price of a potential license. Additionally or alternatively, the licensing system 106 can allow the license to be accepted and grant access to the selected media file.

FIG. 1 additionally shows that the system 100 can include a media owner 108. In at least one implementation, the media owner 108 is an individual or entity which produces or owns the media file. For example, the media file can include songs, books, text, movies, television programs or any other desired media file. The media owner 108 is the creator or owner of the media file. The media owner 108 can upload the media file to the media storage 104 over the network 102.

FIG. 1 also shows that the system 100 can include a licensee 110. In at least one implementation, the licensee 110 can include any individual or entity that desires to use the media file. For example, the licensee 110 can include a business that desires to use the media file for an advertising or information campaign. The licensee 110 can find terms and download the media file from the media storage 104 over the network 102.

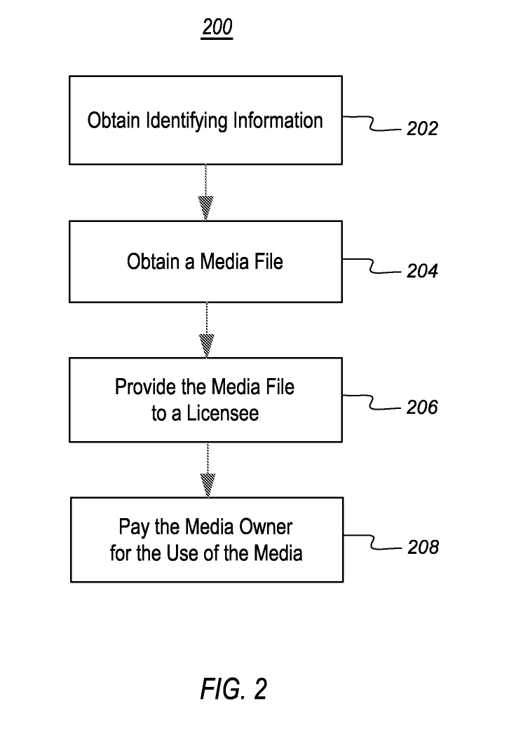

FIG. 2 is a flowchart illustrating a method 200 of licensing a media file. In at least one implementation, the method can be used with a system, such as the system 100 of FIG. 1. Therefore, the method 200 will be described, exemplarily, with reference to the system 100 of FIG. 1. Nevertheless, one of skill in the art can appreciate that the method 200 can be used with a system other than the system 100 of FIG. 1.

FIG. 2 shows that the method 200 can include obtaining 202 identifying information. In at least one implementation, the identifying information can include any desired information about the media owner, creator or media file. For example, the identifying information can include the title of the media file, the media file type, a file type, album, creator, studio, publisher, artist, owner, lyrics or any other information that potential licensees may wish to know about the media file.

FIG. 2 also shows that the method 200 can include obtaining 204 a media file. In at least one implementation, the media file can include an electronic copy of the media file. For example, the media file can include an mp3 file of a song. The media file can be uploaded over a network or obtained 204 using another method.

FIG. 2 further shows that the method 200 can include providing 206 the media file to a licensee. In at least one implementation, providing 206 the media file to a licensee can include allowing the licensee to download the media file. Additionally or alternatively, providing 206 the media file to a licensee can include providing a physical copy or electronic copy stored on a disk. The licensee may be able to choose his/her preferred method for receiving the media file.

FIG. 2 additionally shows that the method 200 can include paying 208 the media owner for the use of the media file. In at least one implementation, the media owner can be paid 208 based on the license fee paid by the licensee. I.e., the media owner can receive a portion of the fees paid by the licensee. Additionally or alternatively, the media owner can receive a flat fee or can be paid 208 using any other desired criteria.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

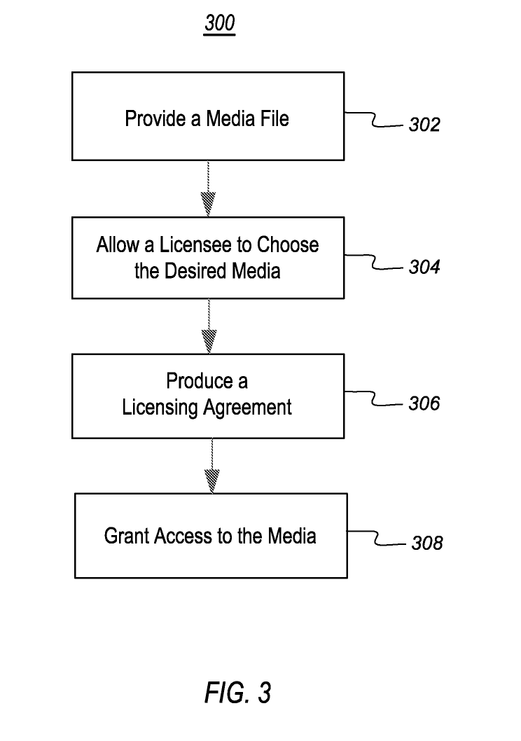

FIG. 3 is a flowchart illustrating a method 300 of licensing a media file. In at least one implementation, licensing a media file can include granting permission to the licensee to use the media file. In particular, the licensee can be authorized to use the media file under the agreed upon conditions, as described below. One of skill in the art will appreciate that the method 300 can allow the license automatically, such that the licensee can have immediate access to the media file.

FIG. 3 shows that the method 300 can include providing 302 a media file. In at least one implementation, the media file can be made available by the media owner. I.e., the media owner can upload or otherwise make the media file available. One of skill in the art will appreciate that multiple media owners can each make available one or more media file for use. For example, multiple bands can each upload multiple songs, making a large number of songs available.

FIG. 3 also shows that the method 300 can include allowing 304 a licensee to choose the desired media file. In at least one implementation, the licensee can browse from among the media file provided 302. I.e., the licensee can view the selection of available media file and choose the media file that he/she prefers. Additionally or alternatively, the licensee can choose keywords, themes or other criteria and media file can be suggested to the licensee.

FIG. 3 further shows that the method 300 can include producing 306 a licensing agreement. In at least one implementation, the licensing agreement can be produced 306 automatically. I.e., the user can agree to licensing terms which are then automatically incorporated into the agreement. Additionally or alternatively, the user can agree to the license electronically, or through some other mechanism, immediately upon being presented the licensing agreement.

FIG. 3 additionally shows that the method 300 can include granting 308 access to the media file. In at least one implementation, granting 308 access to the media file can include making the media file available for download. For example, once the licensing agreement is finalized, the media file can be made available for download on a server. Additionally or alternatively, granting 308 access to the media file can include providing the media file in physical copy, transmitting the media file to the licensee (e.g., via email), sending memory on which the media file has been saved or any other desired method providing the media file to the licensee.

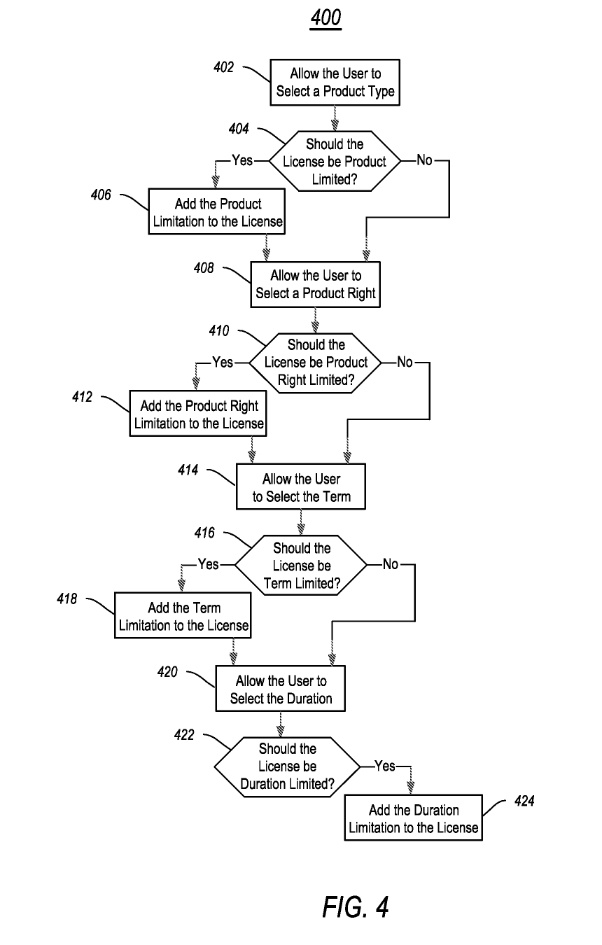

FIG. 4 is a flowchart illustrating a method 400 of producing a sync licensing agreement. In at least one implementation, sync licensing can include allowing a licensee to use the media file or part of the media file for synchronization with other media file. I.e., the media file will be only a portion of the media file created by the licensee.

FIG. 4 shows that the method 400 can include allowing 402 a user to select a product type. In at least one implementation, the product type can include the product into which the media file will be added. For example, the product type can include TV, Theatre, Social Media file, DVD/Home Video, Film, advertising, live performances, website or other media file types. In particular, the product type can include any media file product that the licensee desires to create, of which the media file will be a part. Additionally or alternatively, the product type may include all product types, giving the licensee wide latitude in using the media file.

FIG. 4 also shows that the method 400 can include determining 404 whether the license should be product type limited. In at least one implementation, the licensee selecting specific product types indicates that the license should be product type limited. I.e., if the licensee selects product type limitations, then the license should be product type limited. Additionally or alternatively, the media file can always or never be product type limited, as determined by the system or the media owner.

FIG. 4 further shows that the method 400 can include adding 406 the product type limitation to the license if the license should be product type limited. In at least one implementation, the text of a license agreement can be updated to include the product type limitation. I.e., text describing the product type limitation can be written into the licensing agreement. Additionally or alternatively, the media file can be encoded with the limitation. I.e. the media file can be encoded such that it only works or can be added to the agreed upon product type.

FIG. 4 additionally shows that the method can include allowing 408 the user to select a product right. In at least one implementation, the product right can include the forum in which the product will be exhibited. For example, the product right can include Digital Platforms, Film Festivals, Free Television, Non-Theatrical Exhibition, Pay Television, Theatrical Exhibition, Video/DVD or any other desired forum. Additionally or alternatively, the product right may include all product rights, giving the licensee the authority to exhibit the product in any desired forum.

FIG. 4 also shows that the method 400 can include determining 410 whether the license should be product right limited. In at least one implementation, the licensee selecting specific product rights indicates that the license should be product right limited. I.e., if the licensee selects product right limitations, then the license should be product right limited. Additionally or alternatively, the media file can always or never be product right limited, as determined by the system or the media owner.

FIG. 4 further shows that the method 400 can include adding 412 the product right limitation to the license if the license should be product right limited. In at least one implementation, the text of a license agreement can be updated to include the product right limitation. I.e., text describing the product right limitation can be written into the licensing agreement. Additionally or alternatively, the media file can be encoded with the limitation. I.e. the media file can be encoded such that it only works or can be added to the agreed upon product right.

FIG. 4 additionally shows that the method can include allowing 414 the user to select a term. In at least one implementation, the term can include the time limit for which the license will be valid. For example, the term can include 1 month, 6 months, 1 year, 2 years, 3 years, 5 years or 10 years. Additionally or alternatively, the term may include no limit all terms, giving the licensee the authority to exhibit the product in perpetuity.

FIG. 4 also shows that the method 400 can include determining 416 whether the license should be term limited. In at least one implementation, the licensee selecting specific term types indicates that the license should be term limited. I.e., if the licensee selects term limitations, then the license should be term limited. Additionally or alternatively, the media file can always or never be term limited, as determined by the system or the media owner.

FIG. 4 further shows that the method 400 can include adding 418 the term limitation to the license if the license should be term limited. In at least one implementation, the text of a license agreement can be updated to include the term limitation. I.e., text describing the term limitation can be written into the licensing agreement. Additionally or alternatively, the media file can be encoded with the limitation. I.e. the media file can be encoded such that it only works or can be added to the agreed upon term.

FIG. 4 additionally shows that the method can include allowing 420 the user to select a duration. In at least one implementation, the duration can include the length of time that the media file will be used in the product. For example, the duration can include not to exceed 30 sec, not to exceed 1 min, not to exceed 2 min, not to exceed 3 min, not to exceed 4 min or any other desired duration. Additionally or alternatively, the duration may include an unlimited duration, giving the licensee the authority to use the media file for an unlimited amount of time within the product.

FIG. 4 also shows that the method 400 can include determining 422 whether the license should be duration limited. In at least one implementation, the licensee selecting specific duration types indicates that the license should be duration limited. I.e., if the licensee selects duration limitations, then the license should be duration limited. Additionally or alternatively, the media file can always or never be duration limited, as determined by the system or the media owner.

FIG. 4 further shows that the method 400 can include adding 424 the duration limitation to the license if the license should be duration limited. In at least one implementation, the text of a license agreement can be updated to include the duration limitation. I.e., text describing the duration limitation can be written into the licensing agreement. Additionally or alternatively, the media file can be encoded with the limitation. I.e. the media file can be encoded such that it only works or can be added to the agreed upon duration.

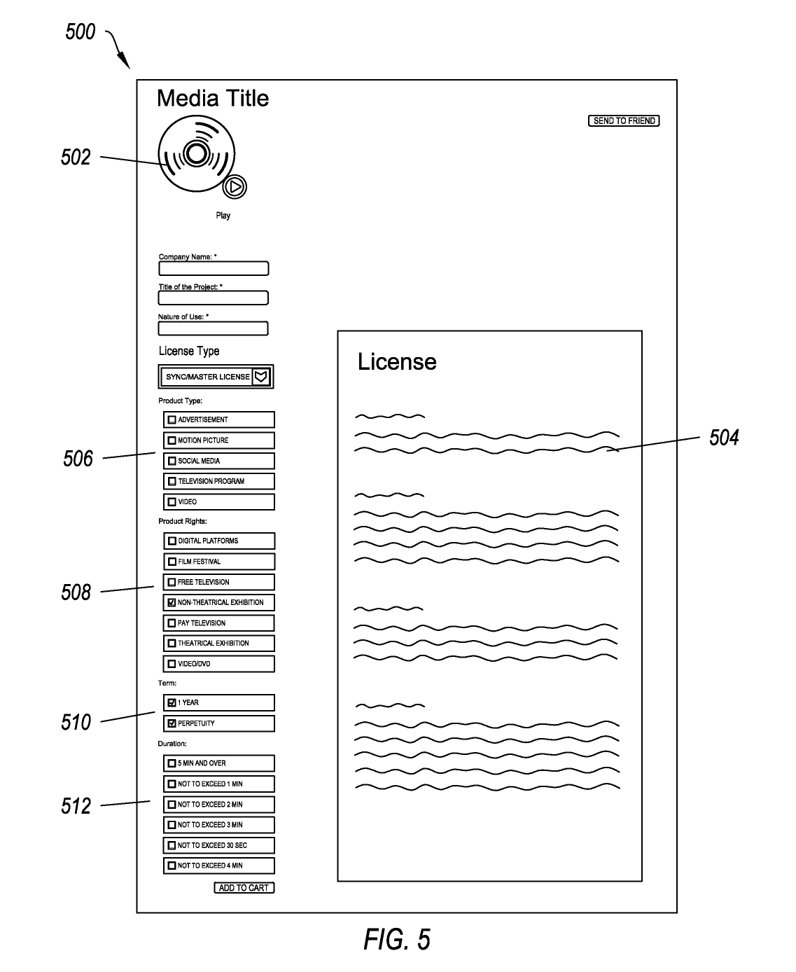

FIG. 5 illustrates an example of a user interface 500 for selecting sync licensing options. In at least one implementation, the user interface 500 can allow the user to view, hear or otherwise interact with the media file. For example, the user interface 500 can include a graphical user interface, controls, speakers, displays or any other necessary hardware and/or software to adequately display the media file to the user, as described below.

In at least one implementation, a graphical user interface (“GUI” sometimes pronounced gooey) is a type of user interface 500 that allows users to interact with electronic devices with images rather than text commands. GUIs can be used in computers, hand-held devices such as MP3 players, portable media file players or gaming devices, cell phones, tablets, household appliances, office equipment and any other desired device. A GUI represents the information and actions available to a user through graphical icons and visual indicators such as secondary notation, as opposed to text-based interfaces, typed command labels or text navigation. The actions are usually performed through direct manipulation of the graphical elements.

FIG. 5 shows that the user interface 500 can include a selected media file 502. In at least one implementation, the licensee can have selected one or more media files which he/she would like to license using an alternative user interface or through some other method. The selected media file 502 can include information for the licensee about the selected media file 502, such as the media owner, the creator, the artist, the length, the type of media file, the file type or any other desired information.

FIG. 5 also shows that the user interface 500 can include a license 504. In at least one implementation, the license can include pre-filled information that is applicable to all licenses. For example, the license can include boilerplate language or other standard language. Additionally or alternatively, the license 504 can include one or more blanks or place holders that are to be filled as the user selects options. For example, the license can include blanks, into which the agreed upon licensing terms will be entered.

FIG. 5 further shows that the user interface 500 can include a license selection area 505. In at least one implementation, the license selection area 505 can allow a user to select a license type. In particular, the license selection area 505 can allow the user to select a sync license or mechanical license. I.e., the user interface 500 can produce the appropriate license 504 and selections, as described below, for the selected license type.

FIG. 5 further shows that the user interface 500 can include a first selection area 506. In at least one implementation, the first selection area 506 can allow a user to select a product type. For example, the user can select from among different product types by selecting the appropriate box in the first selection area 506. The product type can include the product into which the media file will be added. For example, the product type can include TV, Theatre, Social Media file, DVD/Home Video, Film, advertising, marketing, live performances, website or other media file types. In particular, the product can include any media file product that the licensee desires to create, of which the media file will be a part. Additionally or alternatively, the product type may include all product types, giving the licensee wide latitude in using the media file. As the user selects the desired product type in the first selection area 506, the selection(s) can be added to the license 504.

FIG. 5 additionally shows that the user interface 500 can include a second selection area 508. In at least one implementation, the second selection area 508 can allow the user to select a product right. For example, the licensee can select from different product rights by selecting the appropriate box in the second selection area 508. The product right can include the forum in which the product will be exhibited. For example, the product right can include Digital Platforms, Film Festivals, Free Television, Non-Theatrical Exhibition, Pay Television, Theatrical Exhibition, Video/DVD or any other desired forum. Additionally or alternatively, the product right may include all product rights, giving the licensee the authority to exhibit the product in any desired forum. As the user selects the desired product rights in the second selection area 508, the selection(s) can be added to the license 504.

FIG. 5 also shows that he user interface 500 can include a third selection area 510. In at least one implementation, the third selection area 510 can allow the licensee to select a term. For example, the licensee can select from different terms by selecting the appropriate box in the third selection area 510. The term can include the time limit for which the license will be valid. For example, the term can include 1 month, 6 months, 1 year, 2 years, 3 years, 5 years or 10 years. Additionally or alternatively, the term may include no limit all terms, giving the licensee the authority to exhibit the product in perpetuity. As the user selects the desired term in the third selection area 510, the selection(s) can be added to the license 504.

FIG. 5 further shows that the user interface 500 can include a fourth selection area 512. In at least one implementation, the fourth selection area 512 can allow the user to select a duration. For example, the licensee can select from different durations by selecting the appropriate box in the fourth selection area 512. The duration can include the length of time that the media file will be used in the product. For example, the duration can include not to exceed 30 sec, not to exceed 1 min, not to exceed 2 min, not to exceed 3 min, not to exceed 4 min or any other desired duration. Additionally or alternatively, the duration may include an unlimited duration, giving the licensee the authority to use the media file for an unlimited amount of time within the product. As the user selects the desired duration in the fourth selection area 512, the selection(s) can be added to the license 504.

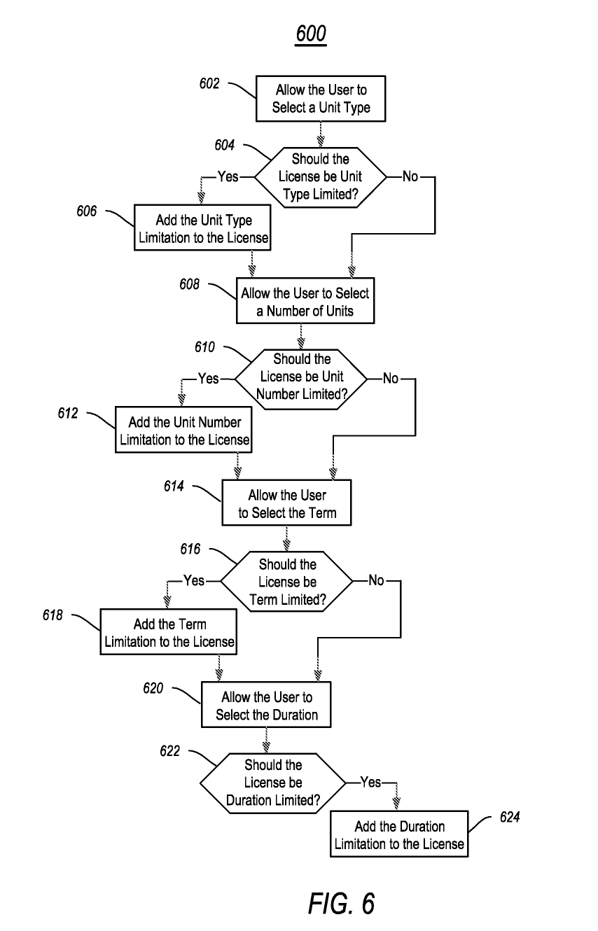

FIG. 6 is a flowchart illustrating a method 600 of producing a mechanical licensing agreement. In at least one implementation, mechanical licensing can include allowing a licensee to use the media file or part of the media file within a mechanical device. I.e., the media file will be played back within a mechanical device which is sold by the licensee.

FIG. 6 shows that the method 600 can include allowing 602 a user to select a unit type. In at least one implementation, the unit type can include the unit into which the media file will be added. For example, the unit type can include greeting cards, balloons, video games, toys, seasonal products, retail products or any other mechanical device. In particular, the unit type can include any mechanical device that the licensee desires to create, of which the media file will be a part. Additionally or alternatively, the unit type may include all unit types, giving the licensee wide latitude in using the media file.

FIG. 6 also shows that the method 600 can include determining 604 whether the license should be unit type limited. In at least one implementation, the licensee selecting specific unit types indicates that the license should be unit type limited. I.e., if the licensee selects unit type limitations, then the license should be unit limited. Additionally or alternatively, the media file can always or never be unit type limited, as determined by the system or the media owner.

FIG. 6 further shows that the method 600 can include adding 606 the unit type limitation to the license if the license should be unit type limited. In at least one implementation, the text of a license agreement can be updated to include the unit type limitation. I.e., text describing the unit type limitation can be written into the licensing agreement. Additionally or alternatively, the media file can be encoded with the limitation. I.e. the media file can be encoded such that it only works or can be added to the agreed upon unit type.

FIG. 6 additionally shows that the method can include allowing 608 the user to select a number of units. In at least one implementation, the number of units can include the maximum number of units that the licensee can manufacture under the license. For example, the number of units can include 10,000, 20,000, 50,000, 100,000 or any other number of units. Additionally or alternatively, the number of units may include all number of units, giving the licensee the authority to produce as many units as desired.

FIG. 6 also shows that the method 600 can include determining 610 whether the license should be number of units limited. In at least one implementation, the licensee selecting a specific number of units indicates that the license should be limited in the number of units. I.e., if the licensee selects number of unit limitations, then the license should be number of units limited. Additionally or alternatively, the media file can always or never be number of units limited, as determined by the system or the media owner.

FIG. 6 further shows that the method 600 can include adding 612 the number of units limitation to the license if the license should be number of units limited. In at least one implementation, the text of a license agreement can be updated to include the number of units limitation. I.e., text describing the number of units limitation can be written into the licensing agreement. Additionally or alternatively, the media file can be encoded with the limitation. I.e. the media file can be encoded such that it only works or can be added to the agreed upon number of units.

FIG. 6 additionally shows that the method can include allowing 614 the user to select a term. In at least one implementation, the term can include the time limit for which the license will be valid. For example, the term can include 1 month, 6 months, 1 year, 2 years, 3 years, 5 years or 10 years. Additionally or alternatively, the term may include no limit all terms, giving the licensee the authority to produce the units in perpetuity.

FIG. 6 also shows that the method 600 can include determining 616 whether the license should be term limited. In at least one implementation, the licensee selecting specific term types indicates that the license should be term limited. I.e., if the licensee selects term limitations, then the license should be term limited. Additionally or alternatively, the media file can always or never be term limited, as determined by the system or the media owner.

FIG. 6 further shows that the method 600 can include adding 618 the term limitation to the license if the license should be term limited. In at least one implementation, the text of a license agreement can be updated to include the term limitation. I.e., text describing the term limitation can be written into the licensing agreement. Additionally or alternatively, the media file can be encoded with the limitation. I.e. the media file can be encoded such that it only works or can be added to the agreed upon term.

FIG. 6 additionally shows that the method can include allowing 620 the user to select a duration. In at least one implementation, the duration can include the length of time that the media file will be used in the unit. For example, the duration can include not to exceed 30 sec, not to exceed 1 min, not to exceed 2 min, not to exceed 3 min, not to exceed 4 min or any other desired duration. Additionally or alternatively, the duration may include an unlimited duration, giving the licensee the authority to use the media file for an unlimited amount of time within the unit.

FIG. 6 also shows that the method 600 can include determining 622 whether the license should be duration limited. In at least one implementation, the licensee selecting specific duration types indicates that the license should be duration limited. I.e., if the licensee selects duration limitations, then the license should be duration limited. Additionally or alternatively, the media file can always or never be duration limited, as determined by the system or the media owner.

FIG. 6 further shows that the method 600 can include adding 624 the duration limitation to the license if the license should be duration limited. In at least one implementation, the text of a license agreement can be updated to include the duration limitation. I.e., text describing the duration limitation can be written into the licensing agreement. Additionally or alternatively, the media file can be encoded with the limitation. I.e. the media file can be encoded such that it only works or can be added to the agreed upon duration.

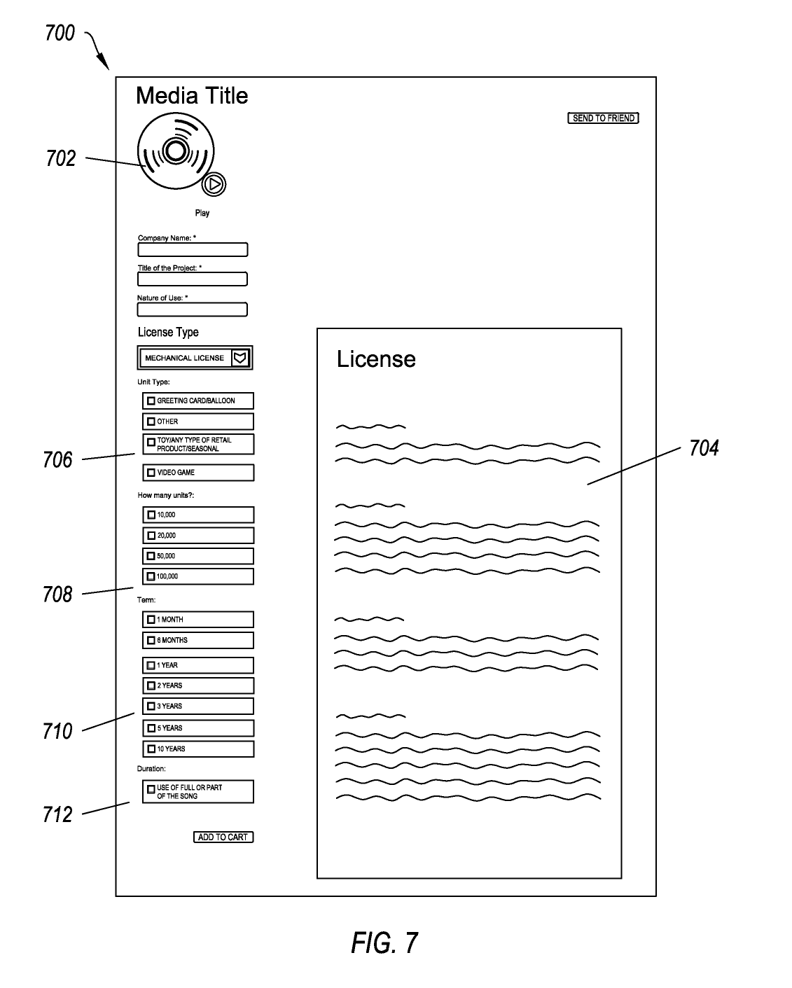

FIG. 7 illustrates an example of a user interface 700 for selecting mechanical licensing options. In at least one implementation, the user interface 700 can allow the user to view, hear or otherwise interact with the media file. For example, the user interface 700 can include a graphical user interface, controls, speakers, displays or any other necessary hardware and/or software to adequately display the media file to the user, as described below.

In at least one implementation, a graphical user interface is a type of user interface 700 that allows users to interact with electronic devices with images rather than text commands. GUIs can be used in computers, hand-held devices such as MP3 players, portable media file players or gaming devices, cell phones, tablets, household appliances, office equipment or any other desired device. A GUI represents the information and actions available to a user through graphical icons and visual indicators such as secondary notation, as opposed to text-based interfaces, typed command labels or text navigation. The actions are usually performed through direct manipulation of the graphical elements.

FIG. 7 shows that the user interface 700 can include a selected media file 702. In at least one implementation, the licensee can have selected one or more media files which he/she would like to license using an alternative user interface or through some other method. The selected media file 702 can include information for the licensee about the selected media file 702, such as the artist, the creator, the owner, the length, the type of media file, the file type or any other desired information.

FIG. 7 also shows that the user interface 700 can include a license 704. In at least one implementation, the license can include pre-filled information that is applicable to all licenses. For example, the license can include boilerplate language or other standard language. Additionally or alternatively, the license 704 can include one or more blanks or place holders that are to be filled as the user selects options. For example, the license can include blanks, into which the agreed upon licensing terms will be entered.

FIG. 7 further shows that the user interface 700 can include a license selection area 705. In at least one implementation, the license selection area 705 can allow a user to select a license type. In particular, the license selection area 705 can allow the user to select a sync license or mechanical license. I.e., the user interface 700 can produce the appropriate license 704 and selections, as described below, for the selected license type.

FIG. 7 further shows that the user interface 700 can include a first selection area 706. In at least one implementation, the first selection area 706 can allow a user to select a unit type. For example, the user can select from among different unit types by selecting the appropriate box in the first selection area 706. The unit type can include the unit into which the media file will be added. For example, the unit type can include greeting cards, balloons, video games, toys, seasonal products, retail products or any other mechanical device. In particular, the unit type can include any mechanical device that the licensee desires to create, of which the media file will be a part. Additionally or alternatively, the unit type may include all unit types, giving the licensee wide latitude in using the media file. As the user selects the desired product type in the first selection area 706, the selection(s) can be added to the license 704.

FIG. 7 additionally shows that the user interface 700 can include a second selection area 708. In at least one implementation, the second selection area 708 can allow the user to select a number of units. For example, the licensee can select the number of units by selecting the appropriate box in the second selection area 708. In at least one implementation, the number of units can include the maximum number of units that the licensee can manufacture under the license. For example, the number of units can include 10,000, 20,000, 50,000, 100,000 or any other number of units. Additionally or alternatively, the number of units may include all number of units, giving the licensee the authority to produce as many units as desired. As the user selects the desired product rights in the second selection area 708, the selection(s) can be added to the license 704.

FIG. 7 also shows that he user interface 700 can include a third selection area 710. In at least one implementation, the third selection area 710 can allow the licensee to select a term. For example, the licensee can select from different terms by selecting the appropriate box in the third selection area 710. The term can include the time limit for which the license will be valid. For example, the term can include 1 month, 6 months, 1 year, 2 years, 3 years, 5 years or 10 years. Additionally or alternatively, the term may include no limit all terms, giving the licensee the authority to exhibit the product in perpetuity. As the user selects the desired term in the third selection area 710, the selection(s) can be added to the license 704.

FIG. 7 further shows that the user interface 700 can include a fourth selection area 712. In at least one implementation, the fourth selection area 712 can allow the user to select a duration. For example, the licensee can select from different durations by selecting the appropriate box in the fourth selection area 712. The duration can include the length of time that the media file will be used in the product. For example, the duration can include not to exceed 30 sec, not to exceed 1 min, not to exceed 2 min, not to exceed 3 min, not to exceed 4 min or any other desired duration. Additionally or alternatively, the duration may include an unlimited duration, giving the licensee the authority to use the media file for an unlimited amount of time within the product. As the user selects the desired duration in the fourth selection area 712, the selection(s) can be added to the license 704.

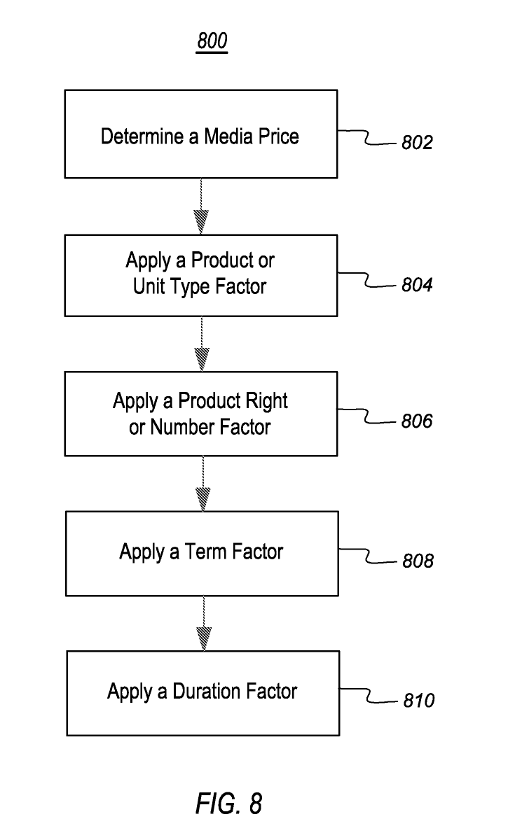

FIG. 8 is a flowchart illustrating an example of a method 800 for pricing a license. In at least one implementation, the method 800 can be used to determine the price regardless of the license type. I.e., the method 800 can be used with both mechanical and sync licensing. The method 800 can be displayed to a user allowing him/her to understand the price implication of his/her choices. I.e., the user can see how much each selection affects the final price to be charged.

FIG. 8 shows that the method 800 can include determining 802 a media file price. In at least one implementation, each media file can be assigned a unique price. For example, more popular media files or media files from more popular media owners can include a larger base price. I.e., if a media file is popular then it will be more expensive than a media file that is less popular. Other factors affecting the media file price can include media owner, studio, publisher, keyword matches or any other desired factor.

FIG. 8 also shows that the method 800 can include applying 804 a product or unit type factor. In at least one implementation, the product type or unit type factor can adjust the price based on the product type or unit type in which the media file will be used. For example, the product or unit type factor can include a multiplier. I.e., the product or unit type factor can proportionally increase or decrease the media file price. Additionally or alternatively, the product or unit type factor can include a set amount that is added to the media file price.

FIG. 8 further shows that the method 800 can include applying 806 a product right or number factor. In at least one implementation, the product right or number factor can adjust the price based on the product rights or number of units in which the media file will be used. For example, the product right or number factor can include a multiplier. I.e., the product right or number factor can proportionally increase or decrease the media file price. Additionally or alternatively, the product right or number factor can include a set amount that is added to the media file price.

FIG. 8 also shows that the method 800 can include applying 808 a term factor. In at least one implementation, the term factor can adjust the price based on the term of the license. I.e., the length of time for which the media file will be used. For example, the term factor can include a multiplier. I.e., the term factor can proportionally increase or decrease the media file price. Additionally or alternatively, the term factor can include a set amount that is added to the media file price.

FIG. 8 also shows that the method 800 can include applying 808 a duration factor. In at least one implementation, the duration factor can adjust the price based on the duration of the media file to be used. I.e., the length of the portion of the media file that will be used. For example, the duration factor can include a multiplier. I.e., the duration factor can proportionally increase or decrease the media file price. Additionally or alternatively, the duration factor can include a set amount that is added to the media file price.

By way of example, a sample price calculation can be shown. One of skill in the art will appreciate that the following is exemplary only and that the factors can be different or applied in a different manner, as described above. The user selects a media file. The user may be given the price information of different media files allowing the user to consider price in selecting the media file. For example, the media file may cost $50 as a base price. The user then selects a product type. If the product type has a product factor of 1.2, then the sub-total can become $60. The user then selects a product right. If the product type has a product right factor of 1.5, then the sub-total can become $90. The user then selects a term. If the product type has a product factor of 2.0, then the sub-total can become $180. The user then selects a duration. If the product type has a product factor of 5, then the sub-total can become $900.

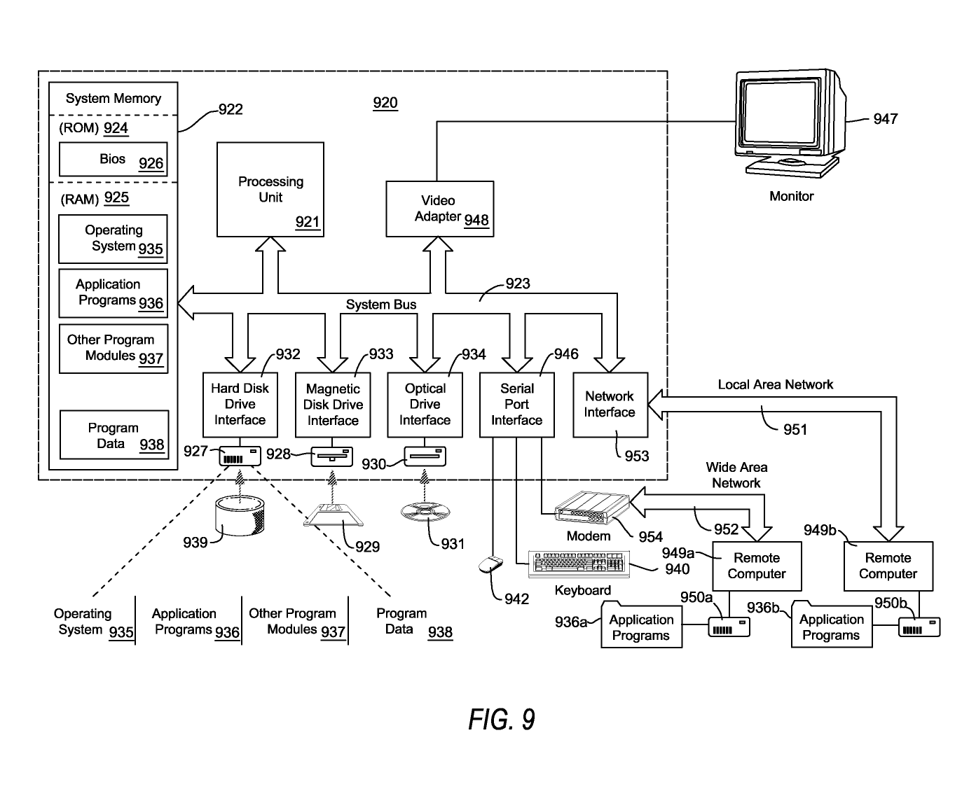

FIG. 9, and the following discussion, is intended to provide a brief, general description of a suitable computing environment in which the invention may be implemented. Although not required, the invention will be described in the general context of computer executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One skilled in the art will appreciate that the invention may be practiced in network computing environments with many types of computer system configurations, including personal computers, tablets, touch screen devices, voice operated devices, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 9, an example system for implementing the invention includes a general purpose computing device in the form of a conventional computer 920, including a processing unit 921, a system memory 922, and a system bus 923 that couples various system components including the system memory 922 to the processing unit 921. It should be noted however, that as mobile phones and other mobile devices become more sophisticated, they are beginning to incorporate many of the components illustrated for conventional computer 920. Accordingly, with relatively minor adjustments, mostly with respect to input/output devices, the description of conventional computer 920 applies equally to mobile phones. The system bus 923 may be any of several types of bus structures including a memory bus or memory controller, a peripheral bus, and a local bus using any of a variety of bus architectures. The system memory includes read only memory (ROM) 924 and random access memory (RAM) 925. A basic input/output system (BIOS) 926, containing the basic routines that help transfer information between elements within the computer 920, such as during start-up, may be stored in ROM 924.

The computer 920 may also include a magnetic hard disk drive 927 for reading from and writing to a magnetic hard disk 939, a magnetic disk drive 928 for reading from or writing to a removable magnetic disk 929, and an optical disc drive 930 for reading from or writing to removable optical disc 931 such as a CD-ROM or other optical media file. The magnetic hard disk drive 927, magnetic disk drive 928, and optical disc drive 930 are connected to the system bus 923 by a hard disk drive interface 932, a magnetic disk drive-interface 933, and an optical drive interface 934, respectively. The drives and their associated computer-readable media file provide nonvolatile storage of computer-executable instructions, data structures, program modules and other data for the computer 920. Although the exemplary environment described herein employs a magnetic hard disk 939, a removable magnetic disk 929 and a removable optical disc 931, other types of computer readable media file for storing data can be used, including magnetic cassettes, flash memory cards, digital versatile discs, Bernoulli cartridges, RAMs, ROMs, cloud storage and the like.

Program code means comprising one or more program modules may be stored on the hard disk 939, magnetic disk 929, optical disc 931, ROM 924 or RAM 925, including an operating system 935, one or more application programs 936, other program modules 937, and program data 938. A user may enter commands and information into the computer 920 through keyboard 940, pointing device 942, or other input devices (not shown), such as a microphone, joy stick, game pad, satellite dish, scanner, or the like. These and other input devices are often connected to the processing unit 921 through a serial port interface 946 coupled to system bus 923. Alternatively, the input devices may be connected by other interfaces, such as a parallel port, a game port or a universal serial bus (USB). A monitor 947 or another display device is also connected to system bus 923 via an interface, such as video adapter 948. In addition to the monitor, personal computers typically include other peripheral output devices (not shown), such as speakers and printers.

The computer 920 may operate in a networked environment using logical connections to one or more remote computers, such as remote computers 949a and 949b. Remote computers 949a and 949b may each be another personal computer, a server, a router, a network PC, a peer device or other common network node, and typically include many or all of the elements described above relative to the computer 920, although only memory storage devices 950a and 950b and their associated application programs 936a and 936b have been illustrated in FIG. 9. The logical connections depicted in FIG. 9 include a local area network (LAN) 951 and a wide area network (WAN) 952 that are presented here by way of example and not limitation. Such networking environments are commonplace in office-wide or enterprise-wide computer networks, intranets and the Internet.

When used in a LAN networking environment, the computer 920 can be connected to the local network 951 through a network interface or adapter 953. When used in a WAN networking environment, the computer 920 may include a modem 954, a wireless link, or other means for establishing communications over the wide area network 952, such as the Internet. The modem 954, which may be internal or external, is connected to the system bus 923 via the serial port interface 946. In a networked environment, program modules depicted relative to the computer 920, or portions thereof, may be stored in the remote memory storage device. It will be appreciated that the network connections shown are exemplary and other means of establishing communications over wide area network 952 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of licensing a media file, the method comprising:
allowing a licensee to select a media file;
producing a licensing agreement; and
granting the licensee access to the media file.

2. The method of claim 1, wherein the licensing agreement includes a sync license.

3. The method of claim 2, wherein the sync license includes a product type limitation.

4. The method of claim 2, wherein the sync license includes a product right limitation.

5. The method of claim 1, wherein the licensing agreement includes a mechanical license.

6. The method of claim 5, wherein the mechanical license includes a unit type limitation.

7. The method of claim 5, wherein the mechanical license includes a unit number limitation.

8. A system for allowing a user to obtain an immediate license to a media file, the system comprising:
media storage, wherein the media storage is configured to store at least two media files; and
a graphical user interface, wherein the graphical user interface is configured to:
allow a licensee to select at least one of the at least two media files; and
determine the price of a license;
present the license to the licensee; and
provide the licensee access to the selected media file.

9. The system of claim 8, wherein the license includes a term limitation.

10. The system of claim 8, wherein the license includes a duration limitation.

11. The system of claim 8, wherein the graphical user interface is configured to present the license to the licensee.

12. The system of claim 11, wherein the graphical user interface is configured to allow the user to accept the license.

13. A system for allowing a user to obtain an immediate license to a media file, the system comprising:
media storage, wherein the media storage is configured to store at least two media files;
a licensing system, wherein the licensing system is configured to:
allow a licensee to select at least one of the at least two media files; and
determine the price of a license;
present the license to the licensee; and
provide the licensee access to the selected media file; and
a network, wherein the network allows the licensee to connect to the licensing system.

14. The system of claim 13, wherein determining the price of the license includes:
determining the base price of the media file.

15. The system of claim 14, wherein determining the price of the license further includes:
applying a product type factor to the base price of the media file.

16. The system of claim 14, wherein determining the price of the license further includes:
applying a unit type factor to the base price of the media file.

17. The system of claim 14, wherein determining the price of the license further includes:
applying a product right factor to the base price of the media file.

18. The system of claim 14, wherein determining the price of the license further includes:
applying a unit number factor to the base price of the media file.

19. The system of claim 14, wherein determining the price of the license further includes:
applying a term factor to the base price of the media file.

20. The system of claim 14, wherein determining the price of the license further includes:
applying a duration factor to the base price of the media file.
